(19) United States
(12) Patent Application Publication
(10) Pub. No.: US 2026/0138244 A1
(43) Pub. Date: May 21, 2026

(54) POCKET BIT DRIVER AND HOLDER

(71) Applicant: Larch Leaves LLC, Bigfork, MT (US)

(72) Inventor: Blair A. Carstensen, Bigfork, MT (US)

(73) Assignee: Larch Leaves LLC, Bigfork, MT (US)

(21) Appl. No.: 19/392,681

(22) Filed: Nov. 18, 2025

Related U.S. Application Data
(60) Provisional application No. 63/721,790, filed on Nov. 18, 2024.

(51) Int. Cl. B25B 23/00; B25G 1/08

(52) U.S. Cl. CPC B25B 23/0028; B25B 23/0035; B25G 1/085

(57) ABSTRACT

A pocket bit driver (10) that is configured to use at least a first driver bit (20A), includes a driver body (12) including (i) a first active bit receiver (14) that is configured to selectively receive and retain the first driver bit (20A), the first active bit receiver (14) being oriented in a first direction (14D) that is parallel to a body length (12L) of the driver body (12), and (ii) a second active bit receiver (16) that is configured to alternatively, selectively receive and retain the first driver bit (20A), the second active bit receiver (16) being oriented in a second direction (16D) that is it an angle relative to the body length (12L) of the driver body (12), the second direction (16D) being different than the first direction (14D). The second direction (16D) can be substantially perpendicular to the body length (12L) of the driver body (12).

### RELATED APPLICATION

This Application is related to and claims priority to U.S. Provisional Patent Application Ser. No. 63/721,790 filed on Nov. 18, 2024, and entitled “POCKET BIT DRIVER AND HOLDER,” the content of which are incorporated in their entirety herein by reference.

### BACKGROUND

The present invention relates generally to the field of hardware tools. More particularly, the present invention relates to a pocket bit driver, holder and handle that provides certain advantages in comparison to currently existing drivers.

Many pocket bit driver devices exist in the market of hardware tools. However, currently existing drivers exhibit certain drawbacks for the average consumer that inhibit the ability to use such drivers in a full array of different applications. For example, different currently existing pocket bit driver devices often exhibit drawbacks for the average consumer including, but not limited to, (1) an inability to function in a secure manner during high-torque situations, (2) being larger, bulkier and/or heavier than many other drivers, and thus being more difficult to use for many consumers, (3) having features that are more complex in design, which leads to the drivers being more expensive for the consumer, and (4) being less stable and with more limited control, thus enabling less torque control especially in high-torque situations.

Additionally, there are several multi-tools and screwdrivers currently on the market that feature handles with built-in storage for accessories such as interchangeable driver bits, or small implements within the handle. However, these devices typically exhibit one or more drawbacks such as limited storage capacity, reduced tool durability, bulkier and heavier handle design, overly complex mechanisms for swapping out bits, and higher costs.

Accordingly, there is a need for a pocket bit driver/holder that overcomes the noted disadvantages and/or drawbacks of currently available devices.

### SUMMARY

The present invention is directed toward a pocket bit driver that is configured to use at least a first driver bit. In various embodiments, the pocket bit driver includes a driver body including (i) a first active bit receiver that is configured to selectively receive and retain the first driver bit, the first active bit receiver being oriented in a first direction that is parallel to a body length of the driver body, and (ii) a second active bit receiver that is configured to alternatively, selectively receive and retain the first driver bit, the second active bit receiver being oriented in a second direction that is it an angle relative to the body length of the driver body, the second direction being different than the first direction.

In some embodiments, the second direction is substantially perpendicular to the body length of the driver body.

In many embodiments, the first driver bit is configured to fit snugly within each of the first active bit receiver and the second active bit receiver; and the first driver bit is alternatively, selectively retained within each of the first active bit receiver and the second active bit receiver by a static friction force.

In certain embodiments, the driver body further includes a third active bit receiver that is configured to alternatively, selectively receive and retain a second driver bit that is different than the first driver bit, the third active bit receiver being oriented in a third direction, the third active bit receiver having at least one of a size and shape that is different than a size and shape of the first active bit receiver and the second active bit receiver.

In some embodiments, the third direction is parallel to the body length of the driver body.

In several embodiments, the driver body further includes a first stored bit receiver that is configured to selectively receive, retain and store at least the first driver bit.

In certain embodiments, the first stored bit receiver is formed as a slot that extends longitudinally along the body length of the driver body.

In some embodiments, the first stored bit receiver is configured to selectively receive, retain and store the first driver bit and a second driver bit.

In certain embodiments, the first stored bit receiver is configured to selectively receive, retain and store the first driver bit; and the driver body further includes a second stored bit receiver that is configured to selectively receive, retain and store a second driver bit.

In some embodiments, the first stored bit receiver is between approximately 52% and 65% generally cylindrical-shaped.

In certain embodiments, the first stored bit receiver includes a slide inhibitor that is configured to inhibit the first driver bit from sliding within the first stored bit receiver when the first driver bit is stored within the first stored bit receiver.

In some embodiments, the slide inhibitor is a laterally oriented rib that is positioned at a desired longitudinal position within the first stored bit receiver.

In many embodiments, the driver body has a unibody, one-piece design.

In certain embodiments, the pocket bit driver further includes a body adapter that can be received within each of the first active bit receiver and the second active bit receiver to at least one of extend the body length of the driver body and extend a reach of the pocket bit driver.

The present invention is further directed toward a bit driver assembly including the pocket bit driver as claimed above, and the first driver bit that is alternatively, selectively received and retained within the first active bit receiver and the second active bit receiver.

The present invention is also directed toward a pocket bit driver that is configured to use at least a first driver bit, the pocket bit driver including a driver body including (i) a first active bit receiver that is configured to selectively receive and retain the first driver bit, the first active bit receiver being oriented in a first direction that is parallel to a body length of the driver body, (ii) a second active bit receiver that is configured to alternatively, selectively receive and retain the first driver bit, the second active bit receiver being oriented in a second direction that is substantially perpendicular to the body length of the driver body, and (iii) a first stored bit receiver that is configured to selectively receive, retain and store at least the first driver bit, the first stored bit receiver being formed as a slot that extends longitudinally along the body length of the driver body; wherein the first driver bit is configured to fit snugly within each of the first active bit receiver and the second active bit receiver; and wherein the first driver bit is alternatively, selectively retained within each of the first active bit receiver and the second active bit receiver by a static friction force.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified perspective view illustration of an embodiment of a pocket bit driver having features of the present invention, the pocket bit driver including a first active bit receiver that is oriented in a first (inline) direction that selectively receives a first driver bit to use the pocket bit driver in a first (inline) manner;

FIG. 2 is another simplified perspective view illustration of the pocket bit driver illustrated in FIG. 1, the pocket bit driver further including a second active bit receiver that is oriented in a second (angled) direction that selectively receives the first driver bit to use the pocket bit driver in a second (angled) manner;

FIG. 3 is a simplified perspective view illustration of an embodiment of a body adapter that is usable with the pocket bit driver of FIG. 1;

FIG. 4 is a simplified perspective view illustration of an embodiment of a driver body for the pocket bit driver of FIG. 1, the driver body including two stored bit receivers;

FIG. 5 is a simplified perspective view illustration of another embodiment of the driver body for the pocket bit driver of FIG. 1, the driver body including three stored bit receivers;

FIG. 6 is a simplified perspective view illustration of still another embodiment of the driver body for the pocket bit driver of FIG. 1, the driver body including four stored bit receivers;

FIG. 7 is a simplified perspective view illustration of yet another embodiment of the driver body for the pocket bit driver of FIG. 1, the driver body including five stored bit receivers;

FIG. 8 is a simplified perspective view illustration of still yet another embodiment of the driver body for the pocket bit driver of FIG. 1, the driver body including six stored bit receivers;

FIG. 9 is a simplified perspective view illustration of another embodiment of the pocket bit driver; and

FIG. 10 is a simplified perspective view illustration of a plurality of alternative driver bits that are usable with the pocket bit driver of FIG. 1.

While embodiments of the present invention are susceptible to various modifications and alternative forms, specifics thereof have been shown by way of example and drawings, and are described in detail herein. It is understood, however, that the scope herein is not limited to the particular embodiments described. On the contrary, the intention is to cover modifications, equivalents, and alternatives falling within the spirit and scope herein.

### DESCRIPTION

In various embodiments, the present invention is directed toward a pocket bit driver that overcomes various drawbacks in currently available bit drivers, such as those noted herein above. More particularly, in various embodiments, as described in detail herein below, the pocket bit driver (1) can be conveniently used in a stable, secure, and easily controllable manner, even during high-torque situations; (2) can be usable in hard-to-reach places that are not accessible for many currently available bit drivers; (3) can receive, retain and thus utilize driver bits that can be oriented in different, alternative directions relative to a length of the bit driver in order to be usable in numerous disparate situations; (4) is relatively simple and compact in design; (5) can exhibit enhanced durability; (6) can provide enhanced storage capacity for interchangeable driver bits of different sizes and/or lengths; and (7) is cost-efficient for the user. It is appreciated that the pocket bit driver of the present invention can further provide additional advantages and/or overcome additional drawbacks that are not specifically noted herein.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings.

In the interest of clarity, not all of the routine features of the implementations described herein are shown and described. It is appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it is recognized that such a development effort might be complex and time-consuming, but would nevertheless be a routine undertaking of engineering for those of ordinary skill in the art having the benefit of this disclosure.

FIG. 1 is a simplified perspective view illustration of an embodiment of a pocket bit driver 10 (also sometimes referred to herein as a “bit driver” or a “driver”) having features of the present invention. As illustrated and described herein, in various embodiments, the bit driver 10 is designed to provide many advantages and overcome many drawbacks relative to currently available bit drivers, several of which have been specifically noted herein above.

The design of the bit driver 10 can be varied to accommodate the specific desires of a user of the bit driver 10. In various embodiments, the bit driver 10 includes a driver body 12 that includes a first active bit receiver 14, a second active bit receiver 16, and one or more stored bit receivers 18 (one stored bit receiver 18 is shown in FIG. 1). Additionally, as further illustrated in FIG. 1, the bit driver 10 is usable with a plurality of interchangeable driver bits 20. Alternatively, the bit driver 10 can have a different design, which can include more features and components or fewer features and components than what is specifically shown in FIG. 1.

As described herein, any of the driver bits 20 can be selectively and interchangeably positioned and actively used within the first active bit receiver 14 and/or the second active bit receiver 16.

Moreover, as shown, each of the one or more stored bit receivers 18 are configured to effectively receive and retain (and store) at least one driver bit 20. Thus, in combination, the one or more stored bit receivers 18 can effectively receive and retain (and store) at least one driver bit 20, and more likely a plurality of driver bits 20. As referred to herein, the bit driver 10 and the driver bits 20 can be referred to collectively as a bit driver assembly 22.

As shown in FIG. 1, the first active bit receiver 14 is oriented in a first (inline) direction 14D and is configured to selectively and removably receive and retain a first driver bit 20A in order to use the bit driver 10 in a first (inline) manner. As referred to herein, the first active bit receiver 14 being oriented in the first (inline) direction 14D is intended to signify that the first active bit receiver 14 is oriented in a manner that is substantially parallel to a body length 12L of the driver body 12.

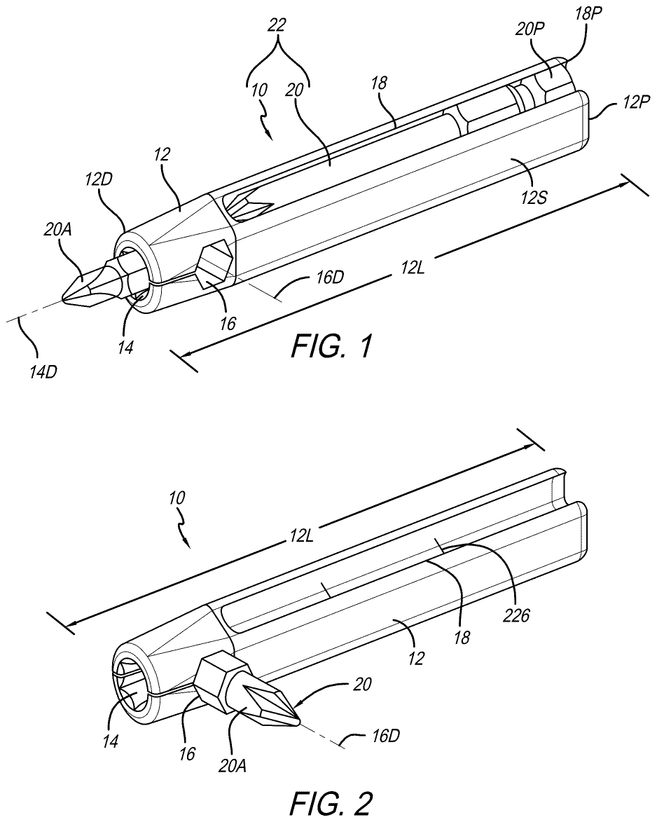

As shown and described in greater detail herein below in relation to FIG. 2, the second active bit receiver 16 is oriented in a second (angled) direction 16D that is different than the first (inline) direction 14D and is configured to selectively and alternatively receive and retain the first driver bit 20A in order to use the bit driver 10 in a second (angled) manner that is different than the first (inline) manner. As referred to herein, the second active bit receiver 16 being oriented in the second (angled) direction 16D is intended to signify that the second active bit receiver 16 is oriented in a manner that is at an angle (non-parallel) relative to the body length 12L of the driver body 12.

The driver body 12 has a body length 12L that extends from a body proximal end 12P to a body distal end 12D. The body length 12L of the driver body 12 can be varied to suit the desires of the user of the bit driver 10. For example, in some non-exclusive embodiments, the driver body 12 can have a body length 12L of between approximately two inches and 12 inches. In other embodiments, the driver body 12 can have a body length 12L of between approximately three inches and eight inches. In still other embodiments, the driver body 12 can have a body length 12L of between approximately three inches and six inches. More particularly, in certain embodiments, the driver body 12 can have a body length 12L that is approximately two inches, three inches, four inches, five inches, six inches, seven inches, eight inches, nine inches, ten inches, 11 inches, or 12 inches. Alternatively, the driver body 12 can have a body length 12L that is greater than approximately 12 inches or less than approximately two inches.

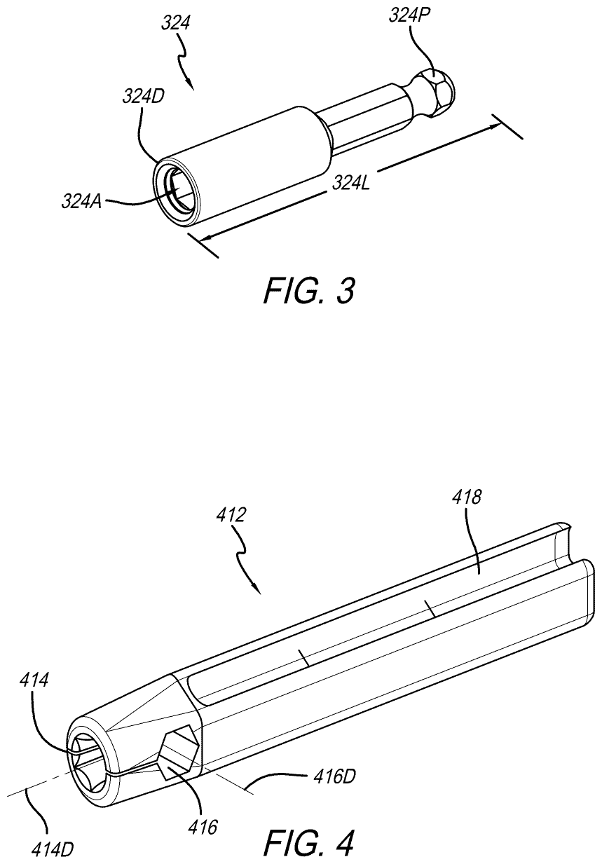

As further illustrated and described herein below, in some embodiments, the bit driver 10 can further include a body adapter 324 (illustrated in FIG. 3), or body extender, that can fit and be received within either or both of the first active bit receiver 14 and the second active bit receiver 16 to effectively extend the body length 12L and/or the reach of the driver body 12 and/or the bit driver 10. It is appreciated that use of the body adapter 324 can generate greater torque for the bit driver 10 and/or better enable the bit driver 10 to reach certain harder to reach places.

In many embodiments, the driver body 12 has a unibody, one-piece design that makes manufacturing simpler, does not require any assembly, and does not have any moving parts. Moreover, as compared to typical currently available bit drivers, the bit driver 10 and/or the driver body 12 of the present invention does not require any magnets, screws, adhesives, covers, caps, springs, clips, bands and/or hinges to become operational. It is appreciated, however, that the user must move the driver bits 20 so that the driver bits 20 can be selectively and alternatively positioned, received and retained within the first active bit receiver 14 and/or the second active bit receiver 16 during use of the bit driver 10, and so that the driver bits 20 can be stored within and/or removed from the stored bit receivers 18.

In some embodiments, the driver body 12 can be configured with one or more side surfaces 12S, such as between and/or adjacent to the one or more stored bit receivers 18, with at least one of the side surfaces 12S being flat in order to inhibit the bit driver 10 from rolling across support surfaces, such as table tops or the floor, as well as enabling the bit driver 10 to be more easily gripped by the user during use. Additionally, the driver body 12 may be smooth, knurled or otherwise textured in order to enhance the comfort and/or controllability for the user. The driver body 12 can further be designed with corners and edges that have been rounded so as to further aid in the comfort for the user.

The driver body 12 can be formed into the desired size, shape and design using any suitable method of manufacture. For example, in some embodiments, the driver body 12 can be formed utilizing methods such as 3-D printing, injection mold, and computer numerical control (CNC) machine. Alternatively, the driver body 12 can be formed using another suitable method of manufacture.

The driver body 12 can be formed from any suitable materials. For example, in certain embodiments, the driver body 12 can be formed from one or more of nylon, glass-filled nylon, polylactic acid, acrylonitrile styrene acrylate (ASA), plastic, urethane, polyethylene, epoxy resins, metal, carbon fiber, and fiberglass. Alternatively, the driver body 12 can be formed from other suitable materials.

The first active bit receiver 14 is formed as an aperture formed at and/or into the body distal end 12D of the driver body 12. As noted above, the first active bit receiver 14 is oriented in the first (inline) direction 14D (i.e. parallel to the body length 12L of the driver body 12) and is configured to selectively receive and retain the first driver bit 20A, or any of the other driver bits 20, in order to use the bit driver 10 in the first (inline) manner.

The first active bit receiver 14 can be configured to selectively receive and retain any suitable driver bits 20, including driver bits 20 of various suitable sizes and lengths. For example, in certain non-exclusive embodiments, the first active bit receiver 14 can be configured to selectively receive and retain driver bits 20 including sizes (such as for a bit proximal end 20P) of 4-mm hex, ¼-inch hex, or 5/16-inch hex, and lengths of one inch, two inches, or three inches. In some embodiments, the first active bit receiver 14 can be configured to selectively receive and retain driver bits 20 having a generally cylindrical-shaped bit proximal end 20P. Alternatively, the driver bits 20 usable within the first active bit receiver 14 can have other suitable sizes and/or lengths.

In some embodiments, the first active bit receiver 14 can be countersunk and chamfered to aid in insertion of the driver bits 20.

In various embodiments, the present invention is designed such that the driver bits 20 fit snugly within the first active bit receiver 14, and such that the driver bits 20 are effectively held in place within the first active bit receiver 14 by a static friction force. By enabling the driver bits 20 to be effectively retained within the first active bit receiver 14 solely by forces of static friction, it is appreciated that the overall design is simplified, not requiring other features or components that are commonly used in currently available bit drivers such as magnets, screws, clips, adhesives, etc.

As shown in this embodiment, the second active bit receiver 16 is formed as an aperture formed near the body distal end 12D of the driver body 12. However, it is appreciated that the second active bit receiver 16 can be formed as an aperture formed at any suitable longitudinal position along the body length 12L of the driver body 12. As further noted above, the second active bit receiver 16 is oriented in the second (angled) direction 16D (i.e. angled relative to the body length 12L of the driver body 12) and is configured to selectively receive and retain the first driver bit 20A, or any of the other driver bits 20, in order to use the bit driver 10 in the second (angled) manner.

Similar to above, the second active bit receiver 16 can be configured to selectively receive and retain any suitable driver bits 20, including driver bits 20 of various suitable sizes and lengths. For example, the second active bit receiver 16 can be configured to selectively receive and retain driver bits 20 substantially identical to those that can be selectively received and retained by the first active bit receiver 14.

In some embodiments, the second active bit receiver 16 can be countersunk and chamfered to aid in insertion of the driver bits 20.

In various embodiments, the present invention is designed such that the driver bits 20 fit snugly within the second active bit receiver 16 such that the driver bits 20 are effectively held in place within the second active bit receiver 16 by a static friction force. As with the first active bit receiver 14, by enabling the driver bits 20 to be effectively retained within the second active bit receiver 16 solely by forces of static friction, it is appreciated that the overall design is simplified, not requiring other features or components such as magnets, screws, clips, adhesives, etc., which are commonly used in currently available bit drivers.

It is appreciated, however, that different driver bits 20 can have different sizes and shapes for a bit proximal end 20P, and the first active bit receiver 14 and/or the second active bit receiver 16 will typically only effectively receive and retain those driver bits 20 in which the size and shape of the bit proximal end 20P matches the size and shape of the first active bit receiver 14 and/or the second active bit receiver 16. Having matching sizes and shapes of the bit proximal end 20P of the driver bits 20, and the apertures that form the first active bit receiver 14 and the second active bit receiver 16, enables the driver bits 20 to fit snugly within the first active bit receiver 14 and/or the second active bit receiver 16 and to be retained solely by a static friction force.

It is further appreciated that driver bits 20 having a bit proximal end 20P of different sizes and shapes as compared to the first active bit receiver 14 and the second active bit receiver 16 can be selectively used with other bit drivers which have an appropriately sized and shaped first active bit receiver and/or second active bit receiver.

However, in some embodiments, the bit driver 10 can further include a receiver size adapter (not shown) that can be positioned within the first active bit receiver 14 and/or the second active bit receiver 16 to enable the bit driver 10 to effectively receive and thus use driver bits 20 with a different size and shape of the bit proximal end 20P. More specifically, the receiver size adapter can include (i) an adapter proximal end that is sized and shaped to fit within the first active bit receiver and/or the second active bit receiver; and (ii) an adapter distal end having an adapter aperture that is sized and shaped to receive and retain the bit proximal end 20P of driver bits 20 in which the bit proximal end 20P is of a different size and shape than those which can be received and retained within the first active bit receiver 14 and/or the second active bit receiver 16. It is appreciated that, in certain embodiments, such features of the receiver size adapter can be incorporated into the body adapter 324.

The design, size and shape of the stored bit receivers 18 can be varied. For example, as shown, the stored bit receivers 18 are formed generally as slots that extend longitudinally along the body length 12L of the driver body 12. It is appreciated that, in different embodiments, the stored bit receivers 18 can extend longitudinally any desired length along the body length 12L of the driver body 12, which can extend fully to the body proximal end 12P or less than fully to the body proximal end 12P. Also, in different embodiments, each of the stored bit receivers 18 in any given embodiment can extend longitudinally approximately the same length or different lengths along the body length 12L of the driver body 12.

In many embodiments, the stored bit receivers 18 are generally partially cylindrical-shaped to allow the driver bits 20 to be effectively positioned therein while also ensuring that the driver bits 20 do not fall out of the stored bit receiver 18 when not desired. In various embodiments, the stored bit receiver 18 is greater than 50% generally cylindrical-shaped. In some embodiments, the stored bit receiver 18 is between approximately 50% and 70% generally cylindrical-shaped. In other embodiments, the stored bit receiver 18 is between approximately 52% and 65% generally cylindrical-shaped. In still other embodiments, the stored bit receiver 18 is between approximately 52% and 60% generally cylindrical-shaped. In yet other embodiments, the stored bit receiver 18 is between approximately 52% and 55% generally cylindrical-shaped. Alternatively, the stored bit receivers 18 can have another suitable design, shape, and/or size.

With such design, the driver bits 20 are effectively received, retained and stored within the stored bit receiver 18, while also enabling the user to easily load and remove the driver bits 20 from the stored bit receiver 18.

In some embodiments, the stored bit receiver 18 can be designed such that a lip of the generally cylindrical-shaped stored bit receiver 18 can flex to further ease loading and removal of the driver bits 20 from the stored bit receiver 18. During loading and removal of the driver bits 20, the driver bits 20 can be stored and removed by the user by pushing/sliding in or out with pressure from a thumb or finger. The stored driver bits are retained by insertion through the reduced opening created within the generally partially cylindrical-shaped design with the flexible lip, with relief slots that create a “spring pressure” effect.

It is appreciated that with the design of the stored bit receiver 18 as described herein, the driver bits 20 will be visible for the user when positioned within the stored bit receiver 18 for easy identification by the user without the need to remove the driver bits 20 from within the stored bit receiver 18. In many embodiments, the driver bits 20 will also be positioned within the stored bit receiver 18 in such a manner that the driver bits 20 do not protrude from the stored bit receiver 18. This enables the bit driver 10 and/or the driver body 12 to be more comfortable to handle and use for the user. On the whole, such design makes the bit driver 10 more easily holdable, transportable and storable.

In certain embodiments, one or more of the stored bit receivers 18 can further include at least one slide inhibitor 226 (illustrated in FIG. 2) that is configured to inhibit the driver bits 20 from sliding within the stored bit receiver 18 when being stored within the stored bit receiver 18. More specifically, when a stored bit receiver 18 is configured to selectively receive, retain and store more than one driver bit 20 therewithin, the slide inhibitor 226 is included to help maintain the driver bits 20 in desired positions within the stored bit receiver 18. Certain embodiments of the slide inhibitor 226 will be described in greater detail herein below in relation to FIG. 2.

In some embodiments, as shown, the stored bit receiver 18 can have a receiver proximal end 18P that has a reduced opening in order to more effectively inhibit the proximally-most positioned driver bit 20 from sliding out of the stored bit receiver 18 in an undesired manner. In certain embodiments, the receiver proximal end 18P of the stored bit receiver 18 can be countersunk and chamfered to aid in insertion of the driver bits 20.

The driver body 12 can include any suitable number of stored bit receivers 18 that extend generally longitudinally along the body length 12L of the driver body 12. For example, in some non-exclusive embodiments, the driver body 12 can include between two and six stored bit receivers 18, which are each configured to receive, retain and store at least one driver bit 20. More particularly, in such embodiments, the driver body 12 can include two, three, four, five, or six stored bit receivers 18 that extend generally longitudinally along the body length 12L of the driver body 12. Alternatively, the driver body 12 can include greater than six stored bit receivers 18 or only one stored bit receiver 18.

The driver body 12 and/or the one or more stored bit receivers 18 can be configured to effectively receive, retain and store any suitable number of driver bits 20 for use within the bit driver 10, with each stored bit receiver 18 being configured to receive any suitable number (and sizes and lengths) of driver bits 20. For example, in some non-exclusive embodiments, the driver body 12 and/or the one or more stored bit receivers 18 can be configured to effectively receive, retain and store between one driver bit 20 and 24 driver bits 20 (such as by including four driver bits 20 in each of six stored bit receivers 18). More particularly, the driver body 12 and/or the one or more stored bit receivers 18 can be configured to effectively receive, retain and store one, two, three, four, five, six, seven, eight, nine, ten, 11, 12, 13, 14, 15, 16, 17, 18, 19, 20, 21, 22, 23, or 24 driver bits 20. Additionally, in certain embodiments, each of the individual stored bit receivers 18 are configured to receive, retain and store from one driver bit 20 to four driver bits 20, with the driver bits 20 in any given stored bit receiver 18 being any suitable size and length depending on the particular design, size, shape and length of the individual stored bit receiver 18. It is appreciated that each of the driver bits 20 received, retained and stored within the stored bit receivers 18 should be specifically usable within the bit driver 10.

However, it is further appreciated that additional driver bits 20 that are not specifically received, retained and stored within the stored bit receivers 18 of the bit driver 10 can also be usable within the bit driver 10.

FIG. 2 is another simplified perspective view illustration of the bit driver 10 illustrated in FIG. 1. As illustrated, the bit driver 10 again is shown to include the driver body 12 having the first active bit receiver 14, the second active bit receiver 16, and the one or more stored bit receivers 18 (only one stored bit receiver 18 is visible in FIG. 2).

As demonstrated more clearly in FIG. 2, the bit driver 10 includes the second active bit receiver 16 that is oriented in the second (angled) direction 16D relative to the body length 12L of the driver body 12. The second active bit receiver 16 selectively receives the first driver bit 20A to use the bit driver 10 in a second (angled) manner.

The second (angled) direction 16D of the second active bit receiver 16, and thus of the first driver bit 20A when selectively received within the second active bit receiver 16, can be varied. For example, in certain non-exclusive embodiments, the second active bit receiver 16 can be angled between approximately 30 degrees and 90 degrees relative to the body length 12L of the driver body 12. In some such embodiments, the second active bit receiver 16 can be angled by approximately 30 degrees, 35 degrees, 40 degrees, 45 degrees, 50 degrees, 55 degrees, 60 degrees, 65 degrees, 70 degrees, 75 degrees, 80 degrees, 85 degrees, or 90 degrees, relative to the body length 12L of the driver body 12. It is appreciated that in the embodiment specifically shown in FIG. 2, the second active bit receiver 16, and thus of the first driver bit 20A when selectively received within the second active bit receiver 16, is angled by approximately 90 degrees relative to the body length 12L of the driver body 12. Stated in another manner, the second active bit receiver 16, and thus of the first driver bit 20A when selectively received within the second active bit receiver 16, is oriented substantially perpendicularly relative to the body length 12L of the driver body 12. Alternatively, the second active bit receiver 16 can be angled in a different manner relative to the body length 12L of the driver body 12.

It is appreciated that by using the bit driver 10 in this second (angled, potentially perpendicular) manner, i.e. utilizing the bit driver 10 with the driver bit 20 oriented in the second (angled, potentially perpendicular) direction 16D, the user can potentially realize greater leverage and/or torque as compared to use in the first (inline) manner. Using the bit driver 10 in the second (angled) manner can also enable the user to effectively access screws in certain hard to reach places that may not otherwise be accessible through use in the first (inline) manner.

As noted above, in certain embodiments, one or more of the stored bit receivers 18 can further include at least one slide inhibitor 226 that is configured to inhibit the driver bits 20 from sliding within the stored bit receiver 18 when being stored within the stored bit receiver 18. More specifically, when a stored bit receiver 18 is configured to selectively receive, retain and store more than one driver bit 20 therewithin, the slide inhibitor 226 is included to help maintain the driver bits 20 in desired positions within the stored bit receiver 18. In some embodiments, as shown for example in FIG. 2, the stored bit receiver 18 can be configured to selectively receive, retain and store three individual driver bits 20 therewithin. In such embodiments, the stored bit receiver 18 can include two slide inhibitors 226 so that the driver bits 20 are retained in a desired position and are inhibited from sliding within the stored bit receiver 18, such as when the stored bit receiver 18 is retaining and storing less than three driver bits 20.

The slide inhibitor 226 can have any suitable design for purposes of effectively inhibiting the driver bits 20 from sliding within the stored bit receiver 18 when being stored within the stored bit receiver 18. For example, in one non-exclusive embodiment, the slide inhibitor 226 can be a laterally oriented rib that is positioned at a desired longitudinal position within the stored bit receiver 18. With such design, the driver bits 20 on either side of the slide inhibitor 226 will abut the slide inhibitor 226, which effectively inhibits the driver bits 20 from moving relative to the slide inhibitor 226. Alternatively, the slide inhibitor 226 can have another suitable design.

FIG. 3 is a simplified perspective view illustration of an embodiment of the body adapter 324 that is usable with the bit driver 10 (illustrated in FIG. 1). As noted above, the body adapter 324 can fit within either or both of the first active bit receiver 14 (illustrated in FIG. 1) and the second active bit receiver 16 (illustrated in FIG. 1) to effectively extend the body length 12L (illustrated in FIG. 1) and/or the reach of the driver body 12 (illustrated in FIG. 1) and/or the bit driver 10. As further noted above, it is appreciated that use of the body adapter 324 can generate greater torque for the bit driver 10 and/or better enable the bit driver 10 to reach certain harder to reach places.

The design, size and shape of the body adapter 324 can be varied to suit the desires of the user of the bit driver 10. As shown in FIG. 3, the body adapter 324 includes an adapter proximal end 324P and an opposed adapter distal end 324D. The body adapter 324 can have any suitable adapter length 324L depending on the extended reach desired by the user. For example, in certain non-exclusive embodiments, the body adapter 324 can have an adapter length 324L of between approximately one inch and four inches. More particularly, in some such embodiments, the body adapter 324 can have an adapter length 324L of approximately one inch, two inches, three inches, or four inches. Alternatively, the body adapter 324 can have an adapter length 324L that is greater than four inches or less than one inch.

When it is determined that it is appropriate and/or necessary to use the body adapter 324, the adapter proximal end 324P can be selectively positioned within the first active bit receiver 14 if it is desired to utilize the bit driver 10 in an inline manner, or the adapter proximal end 324P can be selectively positioned within the second active bit receiver 16 if it is desired to utilize the bit driver 10 in an angled, or perpendicular, manner. It is appreciated that the adapter proximal end 324P will be appropriately sized and shaped to fit snugly and thereby be effectively retained within the first active bit receiver 14 and/or the second active bit receiver 16 utilizing the force of static friction.

As further illustrated, the adapter distal end 324D includes a distal end aperture 324A that is configured to selectively receive and retain any of the driver bits 20 (illustrated in FIG. 1) that may be usable with the particular bit driver 10. Similar to the active bit receivers 14, 16 themselves, the adapter distal end 324D can be configured to utilize static friction in order to effectively retain the driver bit 20 therewithin, with the driver bit 20 fitting snugly within the distal end aperture 324A of the adapter distal end 324D. Alternatively, in other embodiments, the distal end aperture 324A can have a different size and/or shape that enables the bit driver 10 to utilize driver bits 20 (having a bit proximal end 20P (illustrated in FIG. 1) of a different size and/or shape) that would not otherwise be usable with the particular bit driver 10. In such alternative embodiments, the body adapter 324 can function as the receiver size adapter, as described above.

FIG. 4 is a simplified perspective view illustration of an embodiment of a driver body 412 for the bit driver 10 of FIG. 1. The design of the driver body 412 is substantially similar to the embodiments illustrated and described herein above. For example, the driver body 412 again includes (i) a first active bit receiver 414 that is oriented in a first (inline) direction 414D and is configured to selectively receive and retain a driver bit 20 (illustrated in FIG. 1) in order to use the bit driver 10 in a first (inline) manner; (ii) a second active bit receiver 416 that is oriented in a second (angled) direction 416D and is configured to selectively and alternatively receive and retain the driver bit 20 in order to use the bit driver 10 in a second (angled) manner; and (iii) one or more stored bit receivers 418 that can each effectively receive and retain (and store) at least one driver bit 20.

As illustrated in the embodiment shown in FIG. 4, the driver body 412 includes two stored bit receivers 418 (only one stored bit receiver 418 is visible in FIG. 4) that are each configured to selectively receive, retain and store at least one driver bit 20. The stored bit receivers 418 in this embodiment can be substantially similar to those illustrated and described herein above in relation to previous embodiments. Thus, a detailed description of the stored bit receivers 418 will not be repeated.

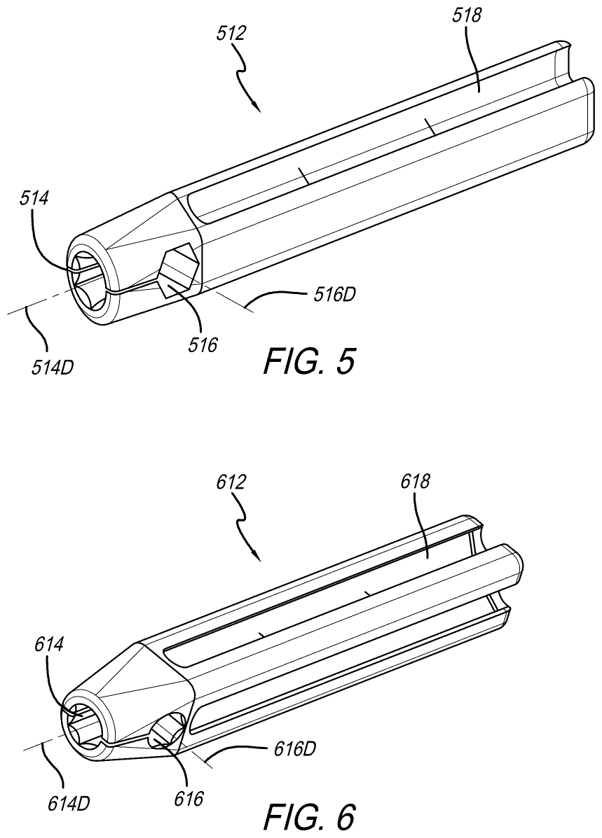

FIG. 5 is a simplified perspective view illustration of another embodiment of the driver body 512 for the bit driver 10 of FIG. 1. The design of the driver body 512 is substantially similar to the embodiments illustrated and described herein above. For example, the driver body 512 yet again includes (i) a first active bit receiver 514 that is oriented in a first (inline) direction 514D and is configured to selectively receive and retain a driver bit 20 (illustrated in FIG. 1) in order to use the bit driver 10 in a first (inline) manner; (ii) a second active bit receiver 516 that is oriented in a second (angled) direction 516D and is configured to selectively and alternatively receive and retain the driver bit 20 in order to use the bit driver 10 in a second (angled) manner; and (iii) one or more stored bit receivers 518 that can each effectively receive and retain (and store) at least one driver bit 20.

As illustrated in the embodiment shown in FIG. 5, the driver body 512 includes three stored bit receivers 518 (only one stored bit receiver 518 is visible in FIG. 5) that are each configured to selectively receive, retain and store at least one driver bit 20. The stored bit receivers 518 in this embodiment can again be substantially similar to those illustrated and described herein above in relation to previous embodiments. Thus, a detailed description of the stored bit receivers 518 will not be repeated.

FIG. 6 is a simplified perspective view illustration of still another embodiment of the driver body 612 for the bit driver 10 of FIG. 1. The design of the driver body 612 is substantially similar to the embodiments illustrated and described herein above. For example, the driver body 612 again includes (i) a first active bit receiver 614 that is oriented in a first (inline) direction 614D and is configured to selectively receive and retain a driver bit 20 (illustrated in FIG. 1) in order to use the bit driver 10 in a first (inline) manner; (ii) a second active bit receiver 616 that is oriented in a second (angled) direction 616D and is configured to selectively and alternatively receive and retain the driver bit 20 in order to use the bit driver 10 in a second (angled) manner; and (iii) one or more stored bit receivers 618 that can each effectively receive and retain (and store) at least one driver bit 20.

As illustrated in the embodiment shown in FIG. 6, the driver body 612 includes four stored bit receivers 618 (only two stored bit receivers 618 are visible in FIG. 6) that are each configured to selectively receive, retain and store at least one driver bit 20. The stored bit receivers 618 in this embodiment can yet again be substantially similar to those illustrated and described herein above in relation to previous embodiments. Thus, a detailed description of the stored bit receivers 618 will not be repeated.

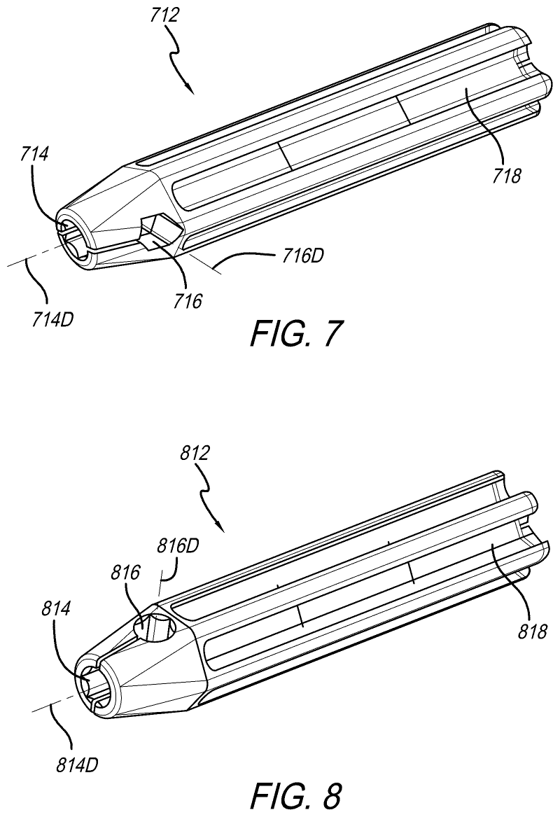

FIG. 7 is a simplified perspective view illustration of yet another embodiment of the driver body 712 for the bit driver 10 of FIG. 1. The design of the driver body 712 is substantially similar to the embodiments illustrated and described herein above. For example, the driver body 712 still again includes (i) a first active bit receiver 714 that is oriented in a first (inline) direction 714D and is configured to selectively receive and retain a driver bit 20 (illustrated in FIG. 1) in order to use the bit driver 10 in a first (inline) manner; (ii) a second active bit receiver 716 that is oriented in a second (angled) direction 716D and is configured to selectively and alternatively receive and retain the driver bit 20 in order to use the bit driver 10 in a second (angled) manner; and (iii) one or more stored bit receivers 718 that can each effectively receive and retain (and store) at least one driver bit 20.

As illustrated in the embodiment shown in FIG. 7, the driver body 712 includes five stored bit receivers 718 (only three stored bit receivers 718 are visible in FIG. 7) that are each configured to selectively receive, retain and store at least one driver bit 20. The stored bit receivers 718 in this embodiment can still again be substantially similar to those illustrated and described herein above in relation to previous embodiments. Thus, a detailed description of the stored bit receivers 718 will not be repeated.

FIG. 8 is a simplified perspective view illustration of still yet another embodiment of the driver body 812 for the bit driver 10 of FIG. 1. The design of the driver body 812 is substantially similar to the embodiments illustrated and described herein above. For example, the driver body 812 still yet again includes (i) a first active bit receiver 814 that is oriented in a first (inline) direction 814D and is configured to selectively receive and retain a driver bit 20 (illustrated in FIG. 1) in order to use the bit driver 10 in a first (inline) manner; (ii) a second active bit receiver 816 that is oriented in a second (angled) direction 816D and is configured to selectively and alternatively receive and retain the driver bit 20 in order to use the bit driver 10 in a second (angled) manner; and (iii) one or more stored bit receivers 818 that can each effectively receive and retain (and store) at least one driver bit 20.

As illustrated in the embodiment shown in FIG. 8, the driver body 812 includes six stored bit receivers 818 (only three stored bit receivers 818 are visible in FIG. 8) that are each configured to selectively receive, retain and store at least one driver bit 20. The stored bit receivers 818 in this embodiment can still yet again be substantially similar to those illustrated and described herein above in relation to previous embodiments. Thus, a detailed description of the stored bit receivers 818 will not be repeated.

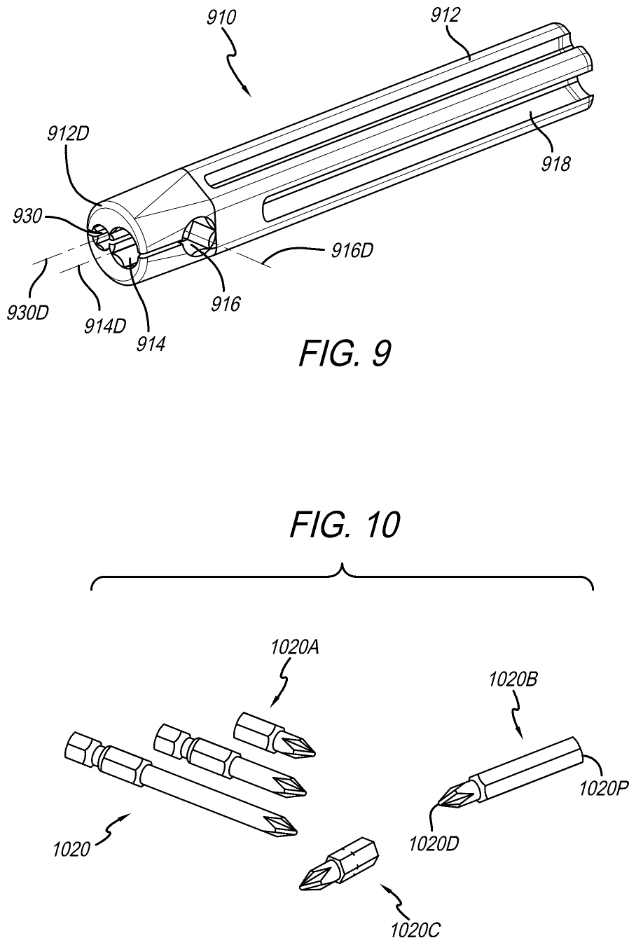

FIG. 9 is a simplified perspective view illustration of another embodiment of the bit driver 910. The bit driver 910 in this embodiment is substantially similar in overall design and functionality to the previous embodiments. For example, as illustrated in FIG. 9, the bit driver 910 again includes a driver body 912 having (i) a first active bit receiver 914 that is oriented in a first (inline) direction 914D and is configured to selectively receive and retain a driver bit 20 (illustrated in FIG. 1) in order to use the bit driver 910 in a first (inline) manner; (ii) a second active bit receiver 916 that is oriented in a second (angled) direction 916D and is configured to selectively and alternatively receive and retain the driver bit 20 in order to use the bit driver 10 in a second (angled) manner; and (iii) one or more stored bit receivers 918 that can each effectively receive and retain (and store) at least one driver bit 20.

However, in this embodiment, the bit driver 910 further includes a third active bit receiver 930. As shown, in certain embodiments, the third active bit receiver 930 can also be formed and/or provided at or near the body distal end 912D. In this specific embodiment, as shown in FIG. 9, the third active bit receiver 930, similar to the first active bit receiver 914, is oriented in a third (inline) direction 930D that is parallel to the first (inline) direction 914D and is configured to selectively receive and retain a driver bit 20 (illustrated in FIG. 1) in order to use the bit driver 910 in a third (inline) manner that is substantially similar to the first (inline) manner.

As further shown in FIG. 9, the third active bit receiver 930 has a size and/or shape that is different than the first active bit receiver 914 and the second active bit receiver 916, thus enabling the third active bit receiver 930 to selectively receive and retain, and thus use, driver bits from a different set of driver bits, i.e. in which the bit proximal end has a different size and/or shape in comparison to the bit proximal end of the driver bits used in the first active bit receiver 914 and the second active bit receiver 916.

In certain alternative embodiments, the third active bit receiver 930 can be oriented in another suitable direction, such as in a third (angled) direction that may be the same as or different from the second (angled) direction 916D for the second active bit receiver 916.

FIG. 10 is a simplified perspective view illustration of a plurality of non-exclusive alternative driver bits 1020 that are usable with the bit driver 10 of FIG. 1. It is appreciated that other sizes, shapes and lengths of the drivers 1020 are also available for potential use with the bit driver 10 beyond what is specifically shown in FIG. 10. Each driver bit 1020 includes a bit distal end 1020D and an opposed bit proximal end 1020P.

The bit distal end 1020D is configured to engage appropriately sized screws during use of the bit driver 10. More specifically, as illustrated, each of the driver bits 1020 has a bit distal end 1020D that is specifically sized and shaped to be used with specifically sized screws during use of the bit driver 10.

The bit proximal end 1020P is configured to fit within and engage the first active bit receiver 14 (illustrated in FIG. 1) and/or the second active bit receiver 16 (illustrated in FIG. 1). It is appreciated that the size and/or shape of the bit proximal end 1020P can be different for different types of driver bits 1020. However, it is further appreciated that driver bits 1020 typically come in sets in which the bit proximal end 1020P for each driver bit 1020 in the set is the same size and shape. Thus, the bit driver 10 will have a first active bit receiver 14 and a second active bit receiver 16 that are of the same size and shape such that any of the driver bits 1020 in a given set will be able to be effectively received and retained, such as with a frictional force, within the active bit receiver 14, 16.

FIG. 10 specifically illustrates three driver bits 1020 that can be included within a first set of driver bits 1040A (such as having a ¼-inch hex design), one driver bit 1020 that can be included within a second set of driver bits 1040B (such as having a 4-mm hex design), and one driver bit 1020 that can be included within a third set of driver bits 1040C (such as having a 5/16-inch hex design). Each set of driver bits 1040A-1040C will be typically usable within a bit driver 10 of a specific design, i.e. with active bit receivers 14, 16 of a specific size and shape. However, in some embodiments, the bit driver 10 can further include a receiver size adapter that can be positioned within the first active bit receiver 14 and/or the second active bit receiver 16 to enable the bit driver 10 to effectively receive and thus use driver bits 1020 from a different set of driver bits 1020A-1020C, i.e. with a different size and shape of the bit proximal end 1020P.

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used herein, the term “comprise” and variations of the term, such as “comprising” and “comprises,” are not intended to exclude other additives, components, integers or steps.

Insofar as the description above discloses any additional subject matter that is not within the scope of the claims below, the inventions are not dedicated to the public and the right to file one or more applications to claim such additional inventions is reserved.

It is understood that although a number of different embodiments of the pocket bit driver 10 have been illustrated and described herein, one or more features of any one embodiment can be combined with one or more features of one or more of the other embodiments, provided that such combination satisfies the intent of the present invention.

While a number of exemplary aspects and embodiments of the pocket bit driver 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope, and no limitations are intended to the details of construction or design herein shown.

What is claimed is:

1. A pocket bit driver that is configured to use at least a first driver bit, the pocket bit driver comprising:
a driver body including (i) a first active bit receiver that is configured to selectively receive and retain the first driver bit, the first active bit receiver being oriented in a first direction that is parallel to a body length of the driver body, and (ii) a second active bit receiver that is configured to alternatively, selectively receive and retain the first driver bit, the second active bit receiver being oriented in a second direction that is it an angle relative to the body length of the driver body, the second direction being different than the first direction.

2. The pocket bit driver of claim 1 wherein the second direction is substantially perpendicular to the body length of the driver body.

3. The pocket bit driver of claim 1 wherein the first driver bit is configured to fit snugly within each of the first active bit receiver and the second active bit receiver; and wherein the first driver bit is alternatively, selectively retained within each of the first active bit receiver and the second active bit receiver by a static friction force.

4. The pocket bit driver of claim 1 wherein the driver body further includes a third active bit receiver that is configured to alternatively, selectively receive and retain a second driver bit that is different than the first driver bit, the third active bit receiver being oriented in a third direction, the third active bit receiver having at least one of a size and shape that is different than a size and shape of the first active bit receiver and the second active bit receiver.

5. The pocket bit driver of claim 4 wherein the third direction is parallel to the body length of the driver body.

6. The pocket bit driver of claim 1 wherein the driver body further includes a first stored bit receiver that is configured to selectively receive, retain and store at least the first driver bit.

7. The pocket bit driver of claim 6 wherein the first stored bit receiver is formed as a slot that extends longitudinally along the body length of the driver body.

8. The pocket bit driver of claim 6 wherein the first stored bit receiver is configured to selectively receive, retain and store the first driver bit and a second driver bit.

9. The pocket bit driver of claim 6 wherein the first stored bit receiver is configured to selectively receive, retain and store the first driver bit; and wherein the driver body further includes a second stored bit receiver that is configured to selectively receive, retain and store a second driver bit.

10. The pocket bit driver of claim 6 wherein the first stored bit receiver is between approximately 52% and 65% generally cylindrical-shaped.

11. The pocket bit driver of claim 6 wherein the first stored bit receiver includes a slide inhibitor that is configured to inhibit the first driver bit from sliding within the first stored bit receiver when the first driver bit is stored within the first stored bit receiver.

12. The pocket bit driver of claim 11 wherein the slide inhibitor is a laterally oriented rib that is positioned at a desired longitudinal position within the first stored bit receiver.

13. The pocket bit driver of claim 1 wherein the driver body has a unibody, one-piece design.

14. The pocket bit driver of claim 1 further including a body adapter that can be received within each of the first active bit receiver and the second active bit receiver to at least one of extend the body length of the driver body and extend a reach of the pocket bit driver.

15. A bit driver assembly including the pocket bit driver of claim 1 and the first driver bit that is alternatively, selectively received and retained within the first active bit receiver and the second active bit receiver.

16. A pocket bit driver that is configured to use at least a first driver bit, the pocket bit driver comprising:
a driver body including (i) a first active bit receiver that is configured to selectively receive and retain the first driver bit, the first active bit receiver being oriented in a first direction that is parallel to a body length of the driver body, (ii) a second active bit receiver that is configured to alternatively, selectively receive and retain the first driver bit, the second active bit receiver being oriented in a second direction that is substantially perpendicular to the body length of the driver body, and (iii) a first stored bit receiver that is configured to selectively receive, retain and store at least the first driver bit, the first stored bit receiver being formed as a slot that extends longitudinally along the body length of the driver body;
wherein the first driver bit is configured to fit snugly within each of the first active bit receiver and the second active bit receiver; and
wherein the first driver bit is alternatively, selectively retained within each of the first active bit receiver and the second active bit receiver by a static friction force.

17. The pocket bit driver of claim 16 wherein the driver body further includes a third active bit receiver that is configured to alternatively, selectively receive and retain a second driver bit that is different than the first driver bit, the third active bit receiver being oriented in a third direction, the third active bit receiver having at least one of a size and shape that is different than a size and shape of the first active bit receiver and the second active bit receiver.

18. The pocket bit driver of claim 16 wherein the first stored bit receiver is configured to selectively receive, retain and store the first driver bit; and wherein the driver body further includes a second stored bit receiver that is configured to selectively receive, retain and store a second driver bit.

19. The pocket bit driver of claim 16 wherein the first stored bit receiver includes a slide inhibitor that is configured to inhibit the first driver bit from sliding within the first stored bit receiver when the first driver bit is stored within the first stored bit receiver.

20. A bit driver assembly including the pocket bit driver of claim 16 and the first driver bit that is alternatively, selectively received and retained within the first active bit receiver and the second active bit receiver.
